(19) United States
(12) Patent Application Publication
(10) Pub. No.: US 2011/0187679 A1
(43) Pub. Date: Aug. 4, 2011

(54) OPTICAL TOUCH DISPLAY DEVICE AND METHOD THEREOF

(75) Inventor: CHUEH-PIN KO, Taipei City (TW)

(73) Assignee: ACER INCORPORATED, TAIPEI COUNTY (TW)

(21) Appl. No.: 12/832,069

(22) Filed: Jul. 8, 2010

(30) Foreign Application Priority Data
Feb. 1, 2010 (TW) 099102895

(51) Int. Cl. G06F 3/042

(52) U.S. Cl. 345/175

(57) ABSTRACT

An optical touch display device includes a display screen, at least one image acquisition module, and a processing module. The display screen includes a display panel and a light emitting module for emitting an invisible light. The image acquisition module acquires an invisible light image reflected by an object located in front of the display panel and irradiated by the invisible light emitted from the light emitting module. The processing module is connected to the display screen and the image acquisition module for receiving the invisible light image acquired by the image acquisition module, performing an image feature analysis on the received invisible light image, and regulating brightness of the invisible light according to a result of the performed image feature analysis. An optical touch display method is also disclosed.

### FIELD OF THE INVENTION

The present invention relates to an optical touch display device and method thereof, and more particularly to an optical touch display device and method thereof that is capable of regulating the intensity of an invisible light.

### BACKGROUND OF THE INVENTION

The currently available infrared (IR) camera-type touch screen utilizes IR light beams emitted from two corners of the touch screen and irradiated on reflecting strips to form a light screen, utilizes sensors arranged at the two corners to receive signal changes on the light screen, and computes a touch position using trigonometric function. While the IR camera-type touch screen has the advantage of applicable to a large-size touch display, it also has the problem of failing to be compact in volume and light in weight because the touch display employing the IR camera-type touch screen must be provided with reflecting strips.

On the other hand, the currently available sensor-embedded optical touch screen utilizes sensors embedded in a touch panel to sense differences in the brightness of a visible light so as to recognize a touch position. The sensor-embedded optical touch screen is advantageous in an integrated manufacturing process to achieve the purpose of reduced panel thickness. However, the sensor-embedded optical touch screen is disadvantageous in that the touch display employing this type of optical touch screen must work in a condition having a predetermined brightness from ambient light or the visible light emitted from a backlight module thereof to enable the function of touch display.

Conventional touch displays have a backlight with a fixed brightness. Therefore, it is not able to resolve minor differences in the image during a proximal touch image analysis; and, during distal object recognition, the resolution is limited due to the fixed brightness of the touch display backlight.

### SUMMARY OF THE INVENTION

A primary object of the present invention is to provide an optical touch display device and method thereof, so as to solve the problem of poor image recognition on an optical touch screen due to fixed the brightness of the light source thereof.

According to the object of the present invention, there is provided an optical touch display device, which includes a display screen, at least one image acquisition module, and a processing module. The display screen includes a display panel for displaying an image, and a light emitting module for emitting a visible light and an invisible light. The image acquisition module acquires an invisible light image reflected by an object located in front of the display panel and irradiated by the invisible light emitted from the light emitting module. The processing module is connected to the display screen and the image acquisition module for receiving the invisible light image acquired by the image acquisition module, performing an image feature analysis on the received invisible light image, and regulating brightness of the invisible light according to a result of the performed image feature analysis.

In the present invention, the invisible light is infrared (IR) light.

In the present invention, the image feature analysis includes any one of a gray level distribution analysis, a contour analysis, a mirror image analysis, and a position analysis.

According to the object of the present invention, there is also provided an optical touch display method, which includes the steps of using a light emitting module of a display screen to emit an invisible light; using at least one image acquisition module to acquire an invisible light image reflected by an object located in front of the display screen and irradiated by the invisible light; and using a processing module to receive the invisible light image, perform an image feature analysis on the received invisible light image, and regulate brightness of the invisible light according to a result of the performed image feature analysis.

In the method of the present invention, the invisible light is infrared (IR) light.

In the method of the present invention, the image feature analysis includes any one of a gray level distribution analysis, a contour analysis, a mirror image analysis, and a position analysis.

Accordingly, the optical touch display device and method thereof according to the present invention has one or more of the following advantages:

(1) With the optical touch display device and method of the present invention, the brightness of the invisible light can be regulated for the proximal touch and the distal spatial object recognition separately or at the same time.

(2) With the optical touch display device and method of the present invention, the differences in image features or the resolution of the image can be increased to solve the problem of a too bright or a too dark image.

(3) With the optical touch display device and method of the present invention, it is able to timely regulate the brightness of the invisible light to achieve the effect of saving electric energy.

(4) With the optical touch display device and method of the present invention, the proximal touch and the distal recognition abilities can be achieved with only one infrared module. Therefore, the problem of requiring two types of IR light sources to achieve the proximal touch and the distal recognition as found in the prior art can be solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an optical touch display device according to a first embodiment of the present invention;

FIG. 2 is a schematic view of the optical touch display device according to the first embodiment of the present invention;

FIG. 3 shows an example of an object contour in an invisible light image acquired by the optical touch display device of the present invention;

FIG. 4 shows an example of a mirror image in an invisible light image acquired by the optical touch display device of the present invention;

FIG. 5 is a cross-sectional view of a display screen of an optical touch display device according to a second embodiment of the present invention; and

FIG. 6 is a flowchart showing the steps included in an optical touch display method according to the present invention.

### DETAILED DESCRIPTION OF THE PREFERRED EMBODIMENTS

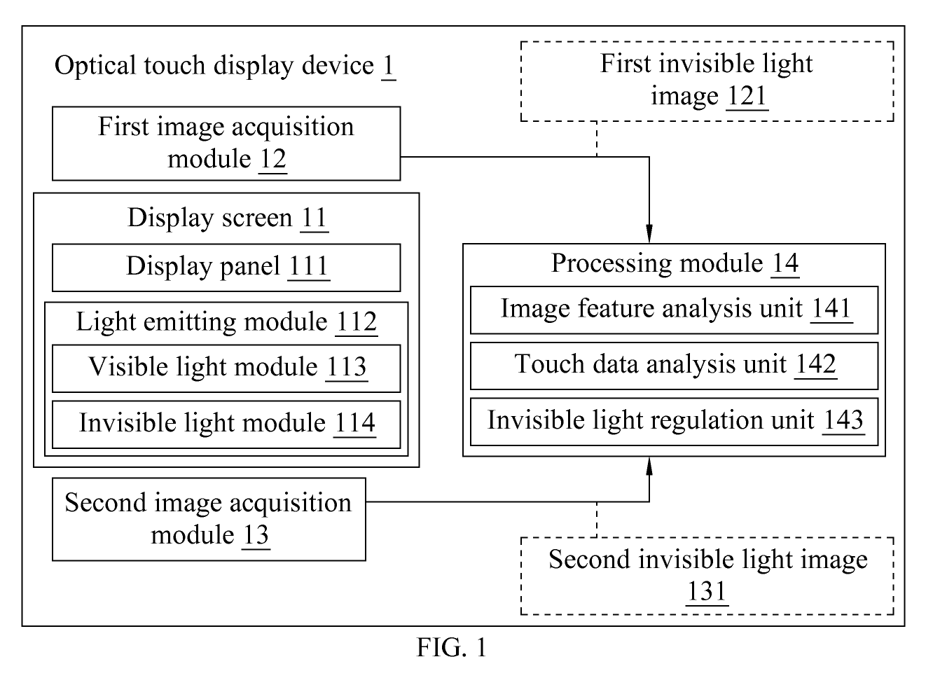

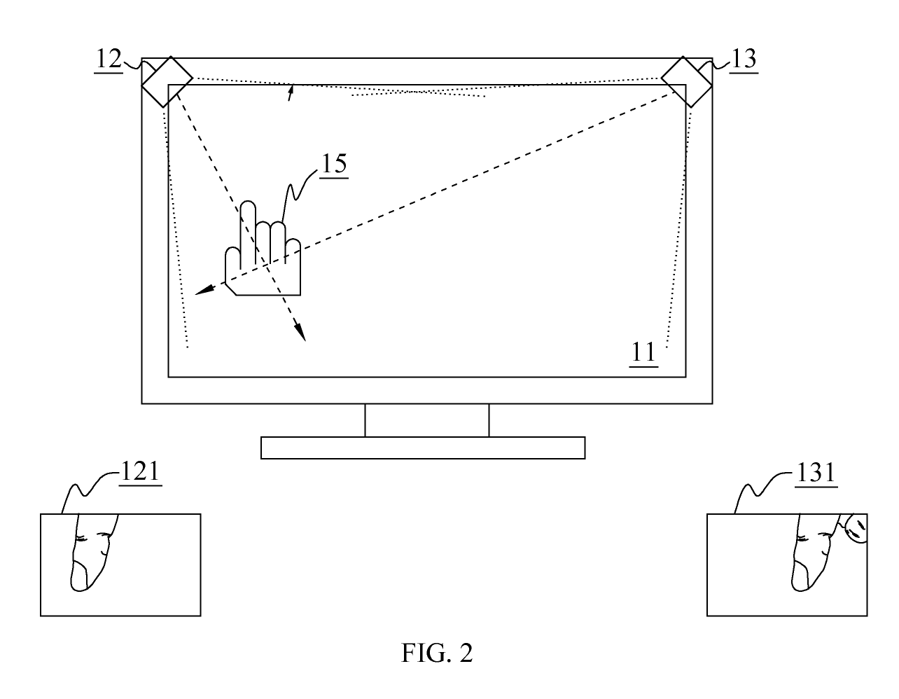

Please refer to FIGS. 1 and 2 that are block diagram and schematic view, respectively, of an optical touch display device 1 according to a first embodiment of the present invention. As shown, the optical touch display device 1 includes a display screen 11, a first image acquisition module 12, a second image acquisition module 13, and a processing module 14. The display screen 11 includes a display panel 111 and a light emitting module 112. The display panel 111 displays images, and is preferably a non-self-luminous display panel, such as a liquid crystal panel or an electrochromic panel; a self-luminous panel, such as an organic light-emitting diode (OLED) panel, a polymeric light-emitting diode (PLED) panel, or a plasma panel; or a specially designed display panel that has IR transmitted-light independent sub-pixels or IR transmitted-light primary color sub-pixels. The light emitting module 112 includes a visible light module 113 and an invisible light module 114. Preferably, the invisible light module 114 is an IR light emitting unit capable of emitting IR light for use as a basic light source in touch display or object recognition. And, different light emitting manners can be designed for the invisible light module 114, such as emitting light continuously; emitting light intermittently in coordination with the first and second image acquisition modules 12, 13, such as emitting light only when the first and second image acquisition modules 12, 13 are acquiring an image; or working based on settings of the display panel 111 to emit invisible light only at a particular frame or a specific frequency.

The first image acquisition module 12 and the second image acquisition module 13 can be respectively arranged at an upper left corner and an upper right corner of the display screen 11, and have an angle of view wide enough for covering a large part of the display screen 11, so as to respectively acquire a first invisible light image 121 and a second invisible light image 131 produced by the invisible light reflected by a touch object 15 located in front of the display screen 11. Herein, a front surface or a space in front of the display screen 11 is defined as a coordinate detection zone.

The processing module 14 is connected to the display screen 11, the first image acquisition module 12, and the second image acquisition module 13. The processing module 14 includes an image feature analysis unit 141, a touch data analysis unit 142, and an invisible light regulation unit 143. The touch data analysis unit 142 is able to analyze the first invisible light image 121 and the second invisible light image 131 received by the processing module 14 to obtain information about the number of touch points, the positions of touch points, touch gestures, or touch height. The image feature analysis unit 141 analyzes image features of the first and the second invisible light image 121, 131. The invisible light regulation unit 143 adjusts a driving current or a driving voltage of the invisible light module 114 according to an image feature analysis result of the image feature analysis unit 141, so as to control an intensity of the invisible light emitted from the invisible light module 114 and obtain invisible light images 121, 131 with increased resolution. To regulate the invisible light intensity, the intensity of the invisible light emitted from the light emitting module 112 can be set to two or more levels, and each of the invisible light intensity levels has a predetermined brightness. Alternatively, the light emitting module 112 can be so set that the intensity of the invisible light from the invisible light module 114 is randomly changeable within a preset cycle to regulate the brightness thereof or the light emitting module 112 can be so set that the emitted invisible light has a specific brightness according to a distance between the touch object and the display screen 11.

Herein, the image feature analysis can be a gray level distribution analysis, a contour analysis, a mirror image analysis, or a position analysis. The gray level distribution analysis can analyze not only the gray level distribution within the invisible light images 121, 131, but also the gray level distribution within a whole zone or a specified zone of the invisible light images 121, 131. For instance, after an analysis of the gray level distribution within a specified zone, such as 50 pixels, of an image, changes in the gray level distribution within the specified zone can be obtained. For example, the gray level distribution can include, but not limited to, 0˜63 levels. When a ratio of the number of pixels at the gray levels 62˜63 to the total pixels in the specified zone exceeds a threshold value, the invisible light regulation unit 143 can reduce the intensity of the invisible light; and the threshold value is preferably set to be 50%. Or, when a ratio of the number of pixels in the invisible light images 121, 131 that are at the gray levels 0˜32 to the total pixels of the whole images is smaller than 10%, the invisible light intensity is reduced. Or, when a zone of a specific size, such as a zone of 50×50 in size in the whole invisible light images 121, 131 is searched; and a ratio of the number of pixels at the gray levels 60˜63 to the total pixels within the zone of the specific size exceeds a threshold value, the invisible light intensity can be reduced until the ratio is lower than the threshold value; and the threshold value is preferably set to be 40%.

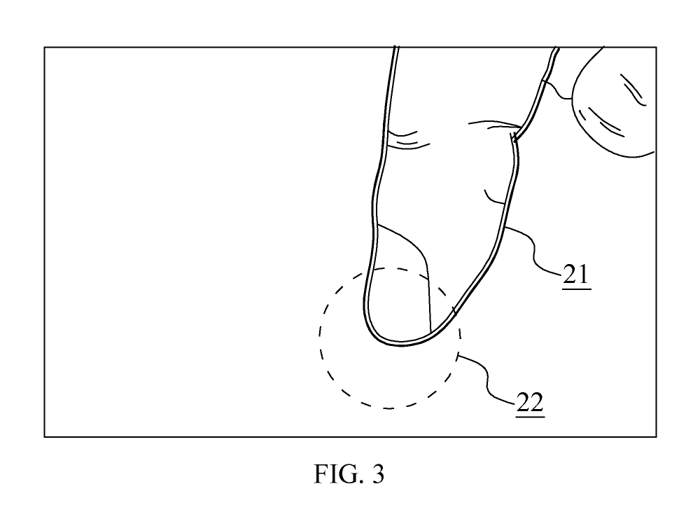

In the contour analysis, the contour, the boundary, or the shape of the invisible light images 121, 131 are analyzed to determine whether the touch object in the invisible light image corresponds to a specific pattern or a non-specific pattern. The specific pattern is preferably a human face or a finger that does not have a geometrical pattern or a touch pen that has a geometrical pattern. In the case the invisible light images 121, 131 are determined as a touch pen, since a touch behavior with a touch pen can be performed without the need of a relatively intensive light source, the invisible light regulation unit 143 can reduce the brightness of the invisible light. On the other hand, in the case it is determined by the image feature analysis unit 141 the invisible light images 121, 131 are not geometrical patterns and correspond to a human face, an analysis of gray level distribution of pixels in the non-geometrical patterned zone can be performed. When a difference between the highest gray level value and the lowest gray level value is smaller than a threshold value, the brightness of the invisible light can be reduced to obtain an increased image recognition rate, and the threshold value is preferably set to be 20. Please refer to FIG. 3 that shows an example of a touch object contour in an invisible light image acquired by the optical touch display device of the present invention. As shown, in the case the invisible light images 121, 131 are determined as a finger 21 in the proximity of the display screen 11, the image feature analysis unit 141 can perform the gray level distribution analysis and the contour analysis at the same time. Since a larger amount of invisible light would be reflected by a portion of the finger contour facing toward the display screen 11 than other portions, a zone with higher brightness in the image can be obtained through the gray level distribution analysis, and then, the position of a touch point 22 or a touch gesture can be obtained through the contour analysis.

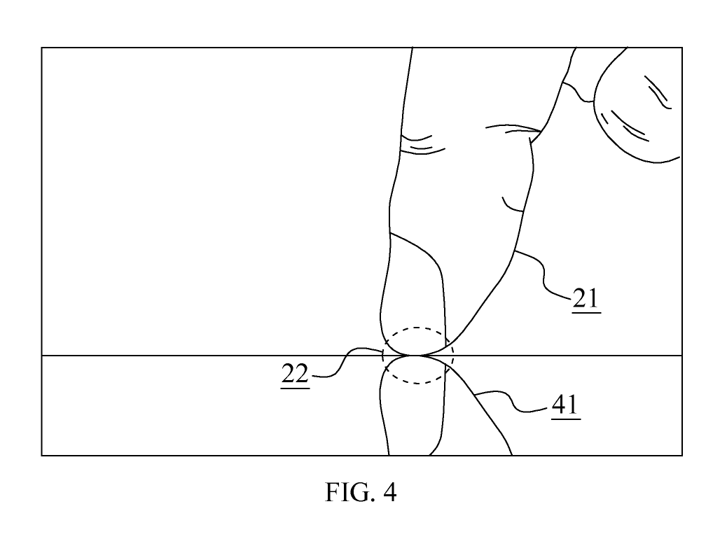

In the case it is determined by the image feature analysis unit 141 there is a mirror image 41 in the invisible light images 121, 131, as shown in FIG. 4, the touch data analysis unit 142 is able to analyze and find the position of a touch point between the touch object and the display screen 11, and the image feature analysis unit 141 can analyze the gray level distribution within the zone surrounding the touch point 22. For example, ten pixels surrounding the touch point 22 are analyzed. When a percentage of the pixels at the gray levels 62˜63 is higher than a threshold value, such as 50%, the brightness of the invisible light is reduced until the percentage is smaller than the threshold value.

In the position analysis, a relative position between the touch object and the display screen 11 is analyzed. The relative position is the coordinate of the touch object. A spatial position of the touch object can be computed based on the first and the second invisible light image 121, 131 using the triangle positioning algorithm. The obtained spatial position is also the coordinate of the touch object in the coordinate detection zone of the display screen 11. The coordinate can be a two-dimensional or a three-dimensional coordinate. When the position of the touch object is a proximal touch position and close to a boundary of the coordinate detection zone, the brightness of the invisible light is increased to enhance the basic light source for image recognition within this zone. Or, when the touch object is located at a relatively distant three-dimensional position, such as a palm distant from the display screen 11 by 30 cm, while the invisible light irradiates on the proximal touch zone, the invisible light regulation unit 143 would increase the invisible light to upgrade the brightness thereof so that the palm can be clearly illuminated. When the invisible light module 114 includes a plurality of IR light emitting units, the processing module 14 can further adjust the weight of light emitted from different IR light emitting units of the invisible light module 114 according to the distance between the touch object and the display screen 11. For example, when a human face distant from the display screen 11 by fifty centimeters (50 cm) can be most clearly recognized, 80% of the IR light emitting units are regulated to emit light toward proximal zones while the other 20% of the IR light emitting units are regulated to emit light toward distal zones. Alternatively, when a human face distant from the display screen 11 by one hundred centimeters (100 cm) can be most clearly recognized, 20% of the IR light emitting units are regulated to emit light toward proximal zones while the other 80% of the IR light emitting units are regulated to emit light toward distal zones. The above-mentioned regulations can be achieved by, for example, adjusting the power supply, the scanning manner, or the resolution of the light emitting module 112 that emits invisible light.

It is noted the above-mentioned analyses can be manually enabled, automatically enabled, or enabled after detection. In the case of manual enabling, the intensity of the invisible light is manually regulated by a user. In the case of automatic enabling, the brightness of the invisible light is automatically regulated by working software according to different touch objects. In the case of enabling after detection, the light emitting module 112 continuously emits invisible light until a touch object moves into the coordinate detection zone, and the image acquisition modules 12, 13 acquire invisible light images 121, 131 that are then analyzed by the processing module 14, and the intensity of the invisible light is regulated according to a result of the image feature analysis performed by the processing module 14. In the present invention, the brightness of the invisible light can be regulated in response to proximal touch and distal spatial object recognition separately or at the same time to provide increased recognition rate. Meanwhile, the effect of saving power energy can be achieved through timely reduction of the brightness of the invisible light.

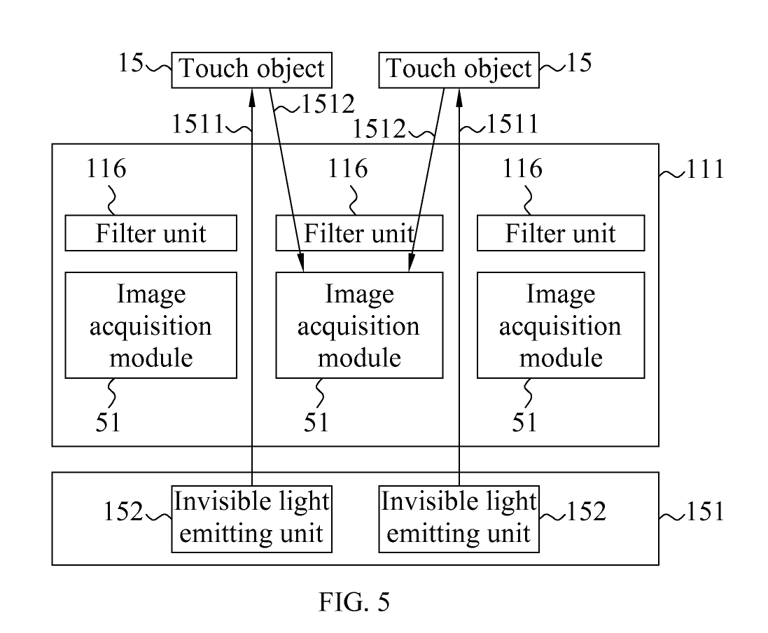

Please refer to FIG. 5 that is a cross-sectional view of a display screen of an optical touch display device according to a second embodiment of the present invention. The second embodiment is different from the first embodiment in that the second embodiment has image acquisition modules 51 arranged inside the display panel 111, and filter units 116 are provided in front of the image acquisition modules 51 to absorb visible light. With these arrangements, the image acquisition modules 51 are able to acquire invisible light 1512 that is reflected by the touch object 15 on or near the display screen 11. Further, the display screen 11 is provided with a backlight module 151, which is able to emit visible light and invisible light 1511. In the present invention, the backlight module 151 is provided behind the display panel 111 and can be a direct-lit backlight module or an edge-lit backlight module. The backlight module 151 includes invisible light emitting units 152 that emit an invisible light 1512. While the image acquisition modules 51 in the illustrated second embodiment are arranged inside the display panel 111, it is understood the image acquisition modules 51 can be otherwise externally attached to a front surface of the display panel 111 without being limited to the illustrated second embodiment. Further, there can be only one or more than one invisible light emitting units 152 provided in the backlight module 151. In the case of having only one invisible light emitting unit 152, the invisible light regulation unit 143 (not shown in FIG. 5) is able to regulate the brightness of the invisible light 1512 according to the coordinate position of the touch object 15, so as to achieve the functions of proximal touch and distal image recognition using only one invisible light emitting unit 152. Or, in the case of having more than one invisible light emitting unit 152, an area sensing in front of the display screen 11 can be achieved. Since all other structures of the second embodiment are similar to the first embodiment, they are not repeatedly discussed herein.

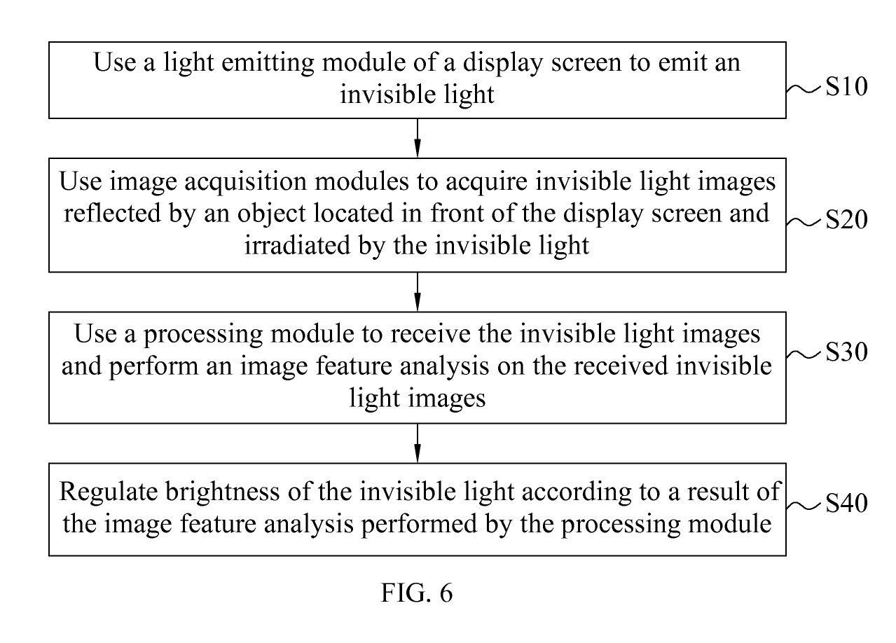

FIG. 6 is a flowchart showing the steps includes in an optical touch display method according to the present invention.

As shown, in a step S10, a light emitting module of a display screen is used to emit an invisible light.

In a step S20, at least one image acquisition module is used to acquire invisible light images reflected by an object that is located in front of the display screen and irradiated by the invisible light emitted from the light emitting module.

In a step S30, a processing module is used to receive the invisible light images and perform an image feature analysis on the received invisible light images.

And, in a step S40, the brightness of the invisible light emitted from the light emitting module is regulated according to a result of the image feature analysis performed by the processing module.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An optical touch display device, comprising:
a display screen including a display panel and a light emitting module, the display panel displaying an image, and the light emitting module emitting a visible light and an invisible light;
at least one image acquisition module being adapted to acquire an invisible light image reflected by an object that is located in front of the display screen and irradiated by the invisible light emitted from the light emitting module; and
a processing module being connected to the display screen and the at least one image acquisition module for receiving the invisible light image reflected by the object and performing an image feature analysis on the received invisible light image, and regulating brightness of the invisible light emitted from the light emitting module according to a result of the performed image feature analysis.

2. The optical touch display device as claimed in claim 1, wherein the image feature analysis includes any one of a gray level distribution analysis, a contour analysis, a mirror image analysis, and a position analysis.

3. The optical touch display device as claimed in claim 2, wherein the processing module performs the gray level distribution analysis and selects to increase or reduce the brightness of the invisible light according to whether a percentage of a specific gray level distribution within the invisible light image exceeds a threshold value.

4. The optical touch display device as claimed in claim 2, wherein the processing module performs the contour analysis to determine whether the invisible light image corresponds to a specific pattern or a non-specific pattern, and regulates the brightness of the invisible light according to whether the invisible light image corresponding to a non-specific pattern has a gray level difference along a contour thereof being larger than a first threshold value, or according to whether the invisible light image corresponding to a specific pattern has a gray level difference in image contents thereof being larger than a second threshold value.

5. The optical touch display device as claimed in claim 2, wherein the invisible light image includes a mirror image of the object touching the display screen; and the processing module performing the mirror image analysis based on the mirror image to obtain a touch point position at where the object touches the display screen, determining whether a percentage of a specific gray level distribution within a zone of the invisible light image covering the touch point position exceeds a threshold value, and regulating the brightness of the invisible light accordingly.

6. The optical touch display device as claimed in claim 2, wherein the position analysis includes determination of a relative position between the object and the display screen.

7. An optical touch display method, comprising the following steps:
using a light emitting module of a display screen to emit an invisible light;
using an image acquisition module to acquire an invisible light image reflected by an object that is located in front of the display screen and irradiated by the invisible light emitted from the light emitting module;
using a processing module to receive the invisible light image and perform an image feature analysis on the received invisible light image; and
using the processing module to regulate brightness of the invisible light according to a result of the performed image feature analysis.

8. The optical touch display method as claimed in claim 7, wherein the image feature analysis includes any one of a gray level distribution analysis, a contour analysis, a mirror image analysis, and a position analysis.

9. The optical touch display method as claimed in claim 8, further comprising the following step when the processing module performs the gray level distribution analysis:
regulating the brightness of the invisible light according to whether a percentage of a specific gray level distribution within the invisible light image exceeds a threshold value.

10. The optical touch display method as claimed in claim 8, further comprising the following steps when the processing module performs the contour analysis:
determining whether the invisible light image corresponds to a specific pattern or a non-specific pattern; and
regulating the brightness of the invisible light according to whether the invisible light image corresponding to a non-specific pattern has a gray level difference along a contour thereof being larger than a first threshold value, or according to whether the invisible light image corresponding to a specific pattern has a gray level difference in image contents thereof being larger than a second threshold value.

11. The optical touch display method as claimed in claim 8, further comprising the following steps when the invisible light image includes a mirror image of the object touching the display screen:
using the processing module to perform the mirror image analysis based on the mirror image to obtain a touch point position at where the object touches the display screen, determining whether a percentage of a specific gray level distribution within a zone of the invisible light image covering the touch point position exceeds a threshold value, and regulating the brightness of the invisible light accordingly.

12. The optical touch display method as claimed in claim 8, wherein the position analysis includes determination of a relative position between the object and the display screen.
